(19) United States
(12) Patent Application Publication
(10) Pub. No.: US 2026/0139900 A1
(43) Pub. Date: May 21, 2026

(54) MANUFACTURING METHOD OF ELECTRODE PLATE, MANUFACTURING METHOD OF POWER STORAGE DEVICE, AND DRYING DEVICE

(71) Applicant: Prime Planet Energy & Solutions, Inc., Tokyo (JP)

(72) Inventor: Tetsuya SAKAKIBARA, Nagoya-shi (JP)

(21) Appl. No.: 19/365,179

(22) Filed: Oct. 22, 2025

(30) Foreign Application Priority Data
Nov. 21, 2024 (JP) 2024-203155

(51) Int. Cl. F26B 13/10; F26B 3/20; H01M 4/04; H01M 10/04

(52) U.S. Cl. CPC F26B 13/101; F26B 3/20; H01M 4/0404; H01M 10/049

(57) ABSTRACT

A method of manufacturing an electrode plate includes applying an active material paste to a surface of a strip-shaped electrode foil to form an undried electrode plate, and drying the active material paste of the undried electrode plate to form an electrode plate having an electrode layer on the surface of the electrode foil and does not have the electrode layer on the back surface of the electrode foil. In the applying, the undried electrode plate is dried from the surface side while being conveyed in a longitudinal direction with the back surface of the undried electrode plate supported by a conveyor belt. The conveyor belt has a belt surface capable of supporting the back surface of the undried electrode plate, and the belt surface is composed of a heat-resistant surface-side resin layer that reduces heat radiation from the back surface of the undried electrode plate, over the entire circumference.

### CROSS-REFERENCE TO RELATED APPLICATIONS

This application is based upon and claims the benefit of priority to Japanese Patent Application No. 2024-203155 filed on Nov. 21, 2024, the entire contents of which are incorporated herein by reference.

### BACKGROUND

### Technical Field

The disclosure relates to a manufacturing method of an electrode plate, a manufacturing method of a power storage device, and a drying device.

### Related Art

Japanese Patent No. 5780226 describes applying an active material paste to a surface of a strip-shaped electrode foil and drying the active material paste using a drying device. Specifically, the active material paste containing active material particles, a binder, and a solvent is applied to the surface of the electrode foil. Then, the active material paste applied to the surface of the electrode foil is heated and dried from the surface side, using the drying device, to form an electrode plate having an electrode layer on the surface of the electrode foil and no electrode layer on the back surface of the electrode foil.

### SUMMARY

### Technical Problems

When the active material paste is heated and dried from the surface side, the solvent evaporates from the surface of the active material paste, and flow of the solvent that moves from the lower side (electrode foil side) to the upper side (surface side of the active material paste) occurs within the active material paste. At this time, the binder dissolved in the solvent also moves from the lower side to the upper side, causing a so-called migration phenomenon. When the migration phenomenon occurs, the amount of the binder on the lower side becomes relatively small within the dried active material paste (electrode layer), which may lead to a reduction in the bonding strength between the surface of the electrode foil and the electrode layer and cause problems such as peel-off of the electrode layer.

In particular, when no electrode layer is present on the back surface of the electrode foil, and the active material paste applied to the surface of the electrode foil is heated and dried from the surface side, the temperature of the back surface of the electrode foil is reduced significantly compared to the temperature of the surface of the active material paste, due to heat radiation from the back surface of the electrode foil. In other words, the difference between the temperature of the surface of the active material paste and that of the back surface of the electrode foil becomes large. As a result, strong convection of the solvent occurs within the active material paste, thereby promoting the migration phenomenon.

The disclosure has been made in view of the above situation, and provides a manufacturing method of an electrode plate, a manufacturing method of a power storage device, and a drying device, which make it possible to manufacture an electrode plate having good bonding strength between a surface of an electrode foil and an electrode layer.

### Means of Solving the Problems

One aspect of the disclosure is a method of manufacturing an electrode plate including a surface-side coating process of applying an active material paste containing active material particles, a binder, and a solvent to a surface of a strip-shaped electrode foil to form an undried electrode plate, and a surface-side drying process of drying the active material paste of the undried electrode plate to form an electrode plate that has an electrode layer on the surface of the electrode foil and does not have the electrode layer on a back surface of the electrode foil. In the surface-side coating process, the undried electrode plate is heated and dried from a surface side while being conveyed in a longitudinal direction with a back surface of the undried electrode plate supported by a conveyor belt, and the conveyor belt has a belt surface capable of supporting the back surface of the undried electrode plate, and the belt surface comprises a heat-resistant resin layer that reduces heat radiation from the back surface of the undried electrode plate to the outside of the undried electrode plate, over an entire circumference.

Another aspect of the disclosure is a method of manufacturing a power storage device including an electrode body forming process of forming an electrode body using the electrode plate manufactured by the method of manufacturing the electrode plate of the disclosure, and housing the electrode body in a case.

Another aspect of the disclosure is a drying device for drying an undried electrode plate in which a surface of a strip-shaped electrode foil is coated with an active material paste containing active material particles, a binder, and a solvent, The drying device includes a heating unit that heats the active material paste of the undried electrode plate from a surface side of the undried electrode plate, and a conveyor belt that conveys the undried electrode plate in a longitudinal direction while supporting a back surface of the undried electrode plate. The conveyor belt has a belt surface capable of supporting the back surface of the undried electrode plate, and the belt surface comprises a heat-resistant resin layer that reduces heat radiation from the back surface of the undried electrode plate to the outside of the undried electrode plate, over an entire circumference.

According to the disclosure, the manufacturing method of the electrode plate, the manufacturing method of the power storage device, and the drying device, which make it possible to manufacture the electrode plate having good bonding strength between the surface of the electrode foil and the electrode layer, are provided.

### BRIEF DESCRIPTION OF THE DRAWINGS

FIG. 1 is a plan view of an electrode plate according to an embodiment;

FIG. 2 is a cross-sectional view, taken along line A-A, of the electrode plate shown in FIG. 1;

FIG. 3 is a cross-sectional view, taken along line B-B, of the electrode plate shown in FIG. 1;

FIG. 4 is a view illustrating a surface-side drying step in the embodiment;

FIG. 5 is a cross-sectional view taken along line C-C shown in FIG. 4;

FIG. 6 is a schematic view of a battery according to an embodiment;

FIG. 7 is a perspective view showing a conveyor belt in a first modified example;

FIG. 8 is a rear view of the conveyor belt as seen from the direction of arrow D shown in FIG. 7;

FIG. 9 is a perspective view showing a conveyor belt in a second modified example; and

FIG. 10 is a cross-sectional view of the conveyor belt in the second modified example.

### DETAILED DESCRIPTION OF THE EXEMPLARY EMBODIMENTS

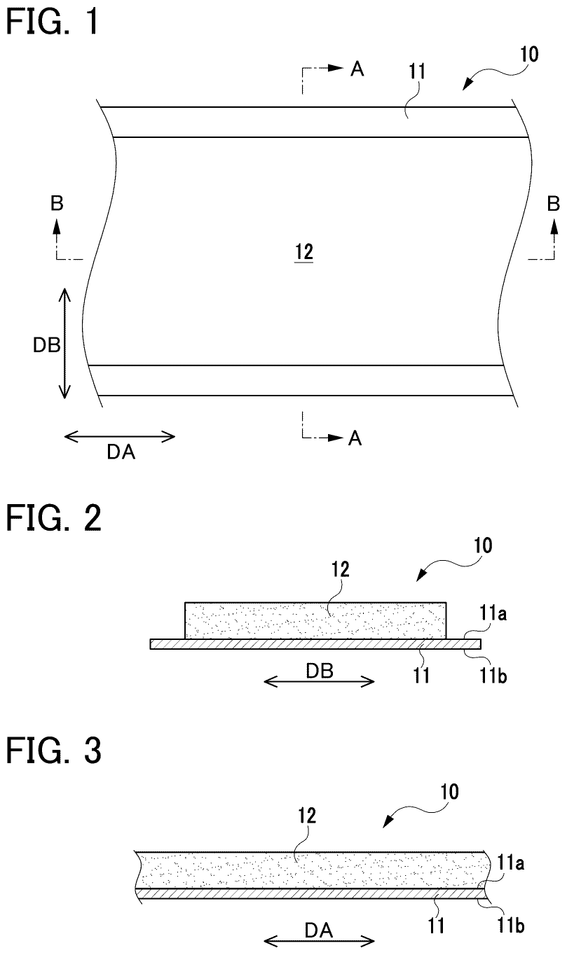

Next, a manufacturing method of an electrode plate, a manufacturing method of a power storage device, and a drying device, according to an embodiment, will be described. The electrode plate 10 of this embodiment has a strip-shaped electrode foil 11 extending in the longitudinal direction DA, and an electrode layer 12 formed on a surface 11a of the electrode foil 11, as shown in FIG. 1 to FIG. 3. The electrode layer 12 is formed on the surface 11a of the electrode foil 11 as described above, but the electrode layer 12 is not formed on a back surface 11b of the electrode foil 11. The electrode layer 12 is obtained by heating and drying an active material paste 12P that will be described below. The electrode layer 12 is provided on a central portion of the surface 11a of the electrode foil 11 in the width direction DB, but is not provided on both end portions of the surface 11a of the electrode foil 11 in the width direction DB. The line dividing the electrode layer 12 into two equal parts in the width direction DB is the same as the line dividing the electrode foil 11 into two equal parts in the width direction DB.

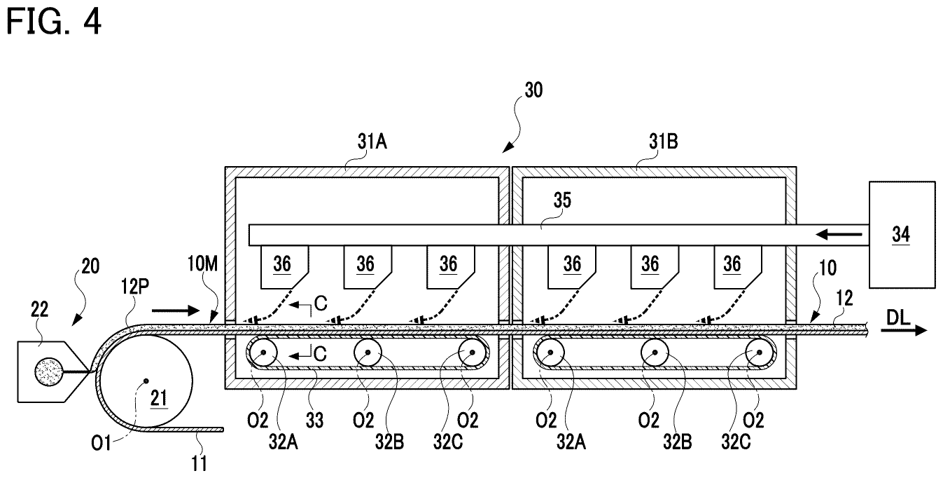

Next, the method of manufacturing the electrode plate 10 described above will be described in detail. In this embodiment, the electrode plate 10 is manufactured using a coating device 20 and a drying device 30, as shown in FIG. 4. The method of manufacturing the electrode plate 10 includes a surface-side coating step of applying the active material paste 12P to the surface 11a of the electrode foil 11, and a surface-side drying step of heating and drying the active material paste 12P applied to the surface 11a of the electrode foil 11 from the surface side. The electrode foil 11 is, for example, an aluminum foil, and the active material paste 12P is obtained by mixing, for example, lithium transition metal composite oxide particles as a positive active material, acetylene black as a conductive material, PVDF as a binder, and NMP (N-methylpyrrolidone) as a solvent, and forming the mixture into a paste.

The coating device 20 is a known die coater, and has a support roll 21 and a die 22, as shown in FIG. 4. The support roll 21 rotates about its axis center O1 to convey the strip-shaped electrode foil 11 in the conveying direction DL. The conveying direction DL is the same as the above-mentioned longitudinal direction DA. The die 22 discharges the active material paste 12P onto the electrode foil 11 conveyed in the conveying direction DL. In this manner, in the surface-side coating step, an undried electrode plate 10M is formed in which the surface 11a of the electrode foil 11 is coated with the active material paste 12P by the coating device 20 while the back surface 11b of the electrode foil 11 is not coated with the active material paste 12P. The active material paste 12P, which has been dried, provides the above-mentioned electrode layer 12.

As shown in FIG. 4, the drying device 30 includes an upstream drying chamber 31A, a downstream drying chamber 31B, multiple conveying rolls 32A, 32B, 32C, respective conveyor belts 33 for respective drying chambers, a gas supply device 34, a duct 35, and multiple air nozzles 36. The internal configuration of the upstream drying chamber 31A is the same as that of the downstream drying chamber 31B; therefore, the configuration of the upstream drying chamber 31A will be described as a typical example.

In the lower section of the upstream drying chamber 31A, the first conveying roll 32A, the second conveying roll 32B, and the third conveying roll 32C are arranged in parallel in the conveying direction DL, as shown in FIG. 4. The conveyor belt 33 spans the first conveying roll 32A, the second conveying roll 32B, and the third conveying roll 32C in an elliptical shape, and each of the conveyor rolls 32A, 32B, 32C is rotatable about its axis center O2 by a motor (not shown). When the motor is driven, the conveyor belt 33 rotates along an elliptical path with the rotation of the conveying rolls 32A, 32B, 32C.

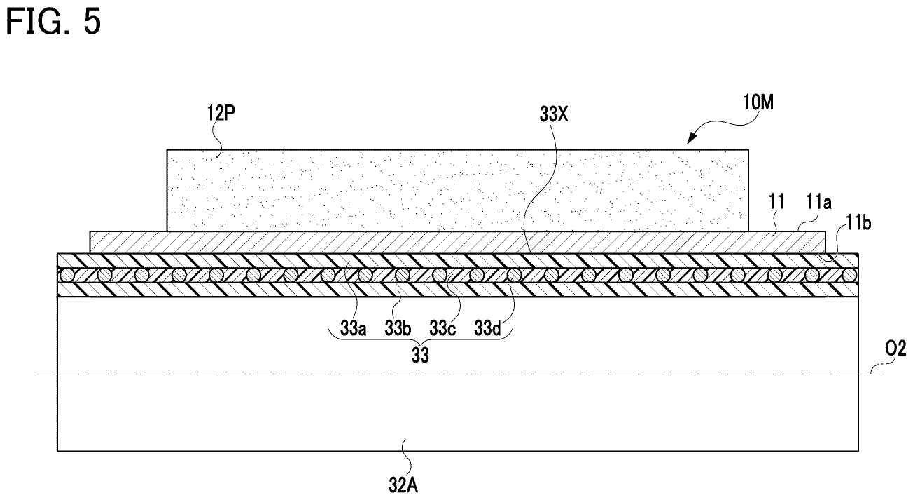

As shown in FIG. 4, the conveyor belt 33 supports the back surface of the undried electrode plate 10M (the back surface 11b of the electrode foil 11), and can convey the undried electrode plate 10M in the conveying direction DL (the longitudinal direction DA) by rotating. As shown in FIG. 5, the conveyor belt 33 supports the entire width DB of the electrode foil 11. The detailed configuration of the conveyor belt 33 will be described below.

The gas supply device 34 is disposed outside the upstream drying chamber 31A and the downstream drying chamber 31B, and communicates with the duct 35, as shown in FIG. 4. The gas supply device 34 has a heater and a blower fan (not shown), and delivers hot air heated by the heater to the duct 35 by means of the blower fan.

The duct 35 is a connecting pipe extending in the conveying direction DL in the upper section of the upstream drying chamber 31A and the upper section of the downstream drying chamber 31B, and is equipped with multiple air nozzles 36. With this arrangement, the hot air delivered from the gas supply device 34 into the duct 35 passes through the duct 35 and is supplied to each of the air nozzles 36.

The air nozzles 36 are arranged at intervals in the conveying direction DL within the upstream drying chamber 31A and the downstream drying chamber 31B. Each of the air nozzles 36 is positioned above the conveyor belt 33 and can deliver the hot air supplied from the duct 35 toward the surface of the undried electrode plate 10M (the surface of the active material paste 12P) conveyed in the conveying direction DL. The hot air delivered from each air nozzle 36 is blown over the entire width DB of the surface of the undried electrode plate 10M (the surface of the active material paste 12P). In the drying device 30, the gas supply device 34, the duct 35, and the air nozzles 36 correspond to the “heating unit”.

Thus, in the surface-side drying step, the drying device 30 conveys the undried electrode plate 10M in the longitudinal direction DA (the conveying direction DL) while supporting the back surface of the undried electrode plate 10M (the back surface 11b of the electrode foil 11) with the conveyor belt 33, and heats and dries the undried electrode plate 10M from the surface side (the upper side in FIG. 4) using hot air. As a result, the active material paste 12P applied to the surface 11a of the electrode foil 11 is dried, and the electrode plate 10 (see FIG. 1 to FIG. 3) which has the electrode layer 12 on the surface 11a of the electrode foil 11 and no electrode layer 12 on the back surface 11b of the electrode foil 11 is formed.

In the surface-side drying step, the solvent evaporates from the surface of the active material paste 12P, causing flow of the solvent moving from the lower side (the electrode foil 11 side) to the upper side (the surface side of the active material paste 12P). At this time, the binder dissolved in the solvent also moves from the lower side to the upper side, resulting in a so-called migration phenomenon. When the migration phenomenon occurs, the amount of the binder on the lower side becomes relatively small within the dried active material paste 12P (the electrode layer 12), causing a reduction in the bonding strength between the electrode foil 11 and the electrode layer 12 and potentially causing the electrode layer 12 to easily peel off.

In particular, when the undried electrode plate 10M, which does not have the electrode layer 12 on the back surface 11b of the electrode foil 11, is heated and dried from the surface side, heat radiation is likely to occur on the back surface 11b of the electrode foil 11 because the back surface 11b of the electrode foil 11 is exposed. Therefore, the temperature of the back surface 11b of the electrode foil 11 becomes significantly lower than the temperature of the surface of the active material paste 12P. In other words, the difference between the temperature of the surface of the active material paste 12P and that of the back surface 11b of the electrode foil 11 becomes large. As a result, strong convection of the solvent occurs within the active material paste 12P, promoting the migration phenomenon. That is, when strong convection of the solvent occurs, even the binder that could remain on the lower side (the electrode foil 11 side) within the active material paste 12P when there is no strong convection of the solvent becomes easier to move to the upper side (the surface side).

Here, the inventors found that when an undried electrode plate, which has the active material paste 12P applied to the surface 11a of the electrode foil 11 and the electrode layer 12 on the back surface 11b of the electrode foil 11, is heated and dried from the surface side, the migration phenomenon is not promoted. This is believed to be because the back surface 11b of the electrode foil 11 is not exposed, so heat radiation is less likely or unlikely to occur on the back surface 11b of the electrode foil 11, and the temperature of the back surface 11b of the electrode foil 11 is not significantly reduced compared to the temperature of the surface of the active material paste 12P, as described above. In other words, when the electrode layer 12 is provided on the back surface 11b of the electrode foil 11, the difference between the temperature of the surface of the active material paste 12P and that of the back surface 11b of the electrode foil 11 does not become large. Therefore, it was found that when the electrode layer 12 is present on the back surface 11b of the electrode foil 11, strong convection of the solvent is less likely or unlikely to occur within the active material paste 12P and the migration phenomenon is not promoted, in the surface-side drying step.

Thus, the inventors constructed the conveyor belt 33 as shown in FIG. 5 so as to reduce the difference between the temperature of the surface of the active material paste 12P and that of the back surface 11b of the electrode foil 11 in the surface-side drying step. FIG. 5 is a cross-sectional view taken along line C-C in FIG. 4. As shown in FIG. 5, the conveyor belt 33 has a surface-side resin layer 33a, a back-side resin layer 33b, an adhesive rubber layer 33c, and multiple steel cords 33d. The length of the conveyor belt 33 in the width direction DB is greater than the length of the electrode foil 11 in the width direction.

The surface-side resin layer 33a and the back-side resin layer 33b are each composed of a heat-resistant resin, such as Teflon (registered trademark). The surface of the surface-side resin layer 33a is in contact with the back surface of the undried electrode plate 10M (the back surface 11b of the electrode foil 11), and the back surface of the surface-side resin layer 33a adheres to the surface of the adhesive rubber layer 33c. The surface of the back-side resin layer 33b adheres to the back surface of the adhesive rubber layer 33c, and the back surface of the back-side resin layer 33b is in contact with the circumferential surface of the first conveying roll 32A. In the adhesive rubber layer 33c, the multiple steel cords 33d are interposed between the surface-side resin layer 33a and the back-side resin layer 33b. The multiple steel cords 33d are high-strength core members extending in the conveying direction DL (the longitudinal direction DA), arranged at intervals in the width direction DB, and serve to reinforce the conveyor belt 33.

With the above arrangement, the belt surface 33X of the conveyor belt 33 can support the entire width DB of the back surface of the undried electrode plate 10M (the back surface 11b of the electrode foil 11). Furthermore, the belt surface 33X is formed, over the entire circumference, of the heat-resistant surface-side resin layer 33a that reduces heat radiation from the back surface of the undried electrode plate 10M (the back surface 11b of the electrode foil 11) to the outside (the lower side) of the undried electrode plate 10M. Therefore, in the surface-side drying step, the belt surface 33X reduces heat radiation from the back surface of the undried electrode plate 10M, thereby reducing the difference between the temperature of the surface of the active material paste 12P and that of the back surface of the undried electrode plate 10M. Accordingly, the convection that occurs within the active material paste 12P can be reduced or eliminated.

In other words, in the surface-side drying step, heat is less likely to be transferred from the back surface of the undried electrode plate 10M (the back surface 11b of the electrode foil 11) to the belt surface 33X of the conveyor belt 33, and the temperature of the back surface 11b of the electrode foil 11 is not significantly reduced compared to the temperature of the surface of the active material paste 12P. As a result, strong convection of the solvent is less likely or unlikely to occur within the active material paste 12P as in the case where the undried electrode plate having the electrode layer 12 on the back surface 11b of the electrode foil 11 is heated and dried from the surface side. As a result, the migration phenomenon can be reduced, and the electrode plate 10 having good bonding strength between the surface 11a of the electrode foil 11 and the electrode layer 12 can be manufactured.

In a known drying device for drying the active material paste 12P, it is common to make the path for conveying the undried electrode plate 10M in the longitudinal direction DA sufficiently long, so that the active material paste 12P is slowly heated and dried. In this way, the migration phenomenon can be reduced as much as possible. In contrast, in this embodiment, the migration phenomenon can be reduced by reducing the difference between the temperature of the surface of the active material paste 12P and that of the back surface of the undried electrode plate 10M, as described above. Therefore, it is not necessary to make the path for conveying the undried electrode plate 10M in the longitudinal direction DA sufficiently long as in the known drying device, and the drying device 30 can be made compact.

In this embodiment, the belt surface 33X is composed of Teflon as a heat-resistant resin layer so that the difference between the temperature of the surface of the active material paste 12P and that of the back surface of the undried electrode plate 10M becomes equal to or less than, for example, 15 degrees, in the surface-side drying step. However, the composition of the belt surface 33X is not limited to Teflon, but may be polypropylene or EPDM (ethylene propylene rubber) as long as it is a heat-resistant resin layer. Thus, the composition of the belt surface 33X can be changed as appropriate.

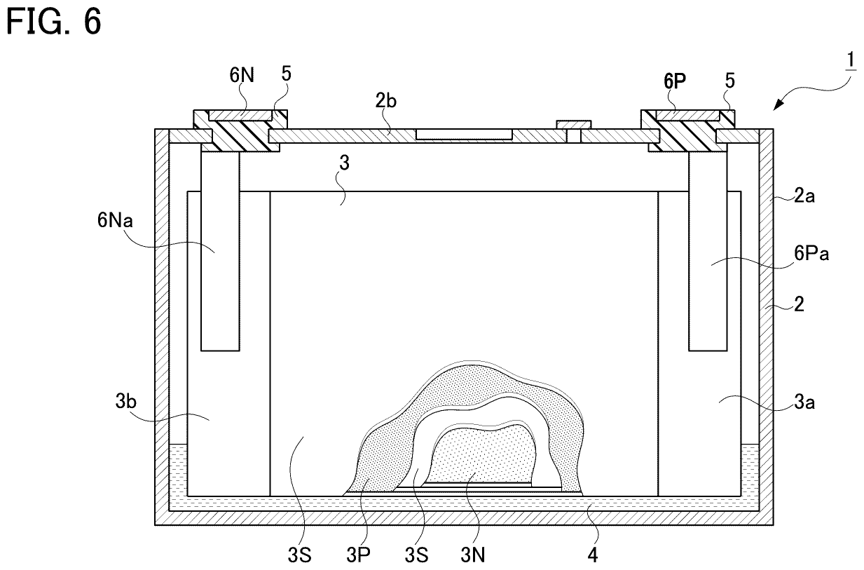

Next, a method of manufacturing a battery 1 (one example of the power storage device of the disclosure) in the form of a lithium-ion secondary battery according to one embodiment will be described. First, the configuration of the battery 1 will be described with reference to FIG. 6. As shown in FIG. 6, the battery 1 includes a case 2, an electrode body 3 housed inside the case 2, and an electrolyte 4. The case 2 is like a rectangular box, and includes a quadrangular tube-like case body 2a with a bottom, and a lid 2b. The peripheral edge of the lid 2b is joined to the upper end of the case body 2a by laser welding. A positive terminal 6P is fixed to one end portion (on the right-hand side in FIG. 6) of the lid 2b via an insulating member 5, and a negative terminal 6N is fixed to the other end portion (on the left-hand side in FIG. 6) of the lid 2b via the insulating member 5.

The electrode body 3 comprises a strip-shaped positive electrode plate 3P and a strip-shaped negative electrode plate 3N, which are wound via a pair of separators 3S and flattened in a direction perpendicular to the plane of the paper in FIG. 6. One end portion (the right end portion in FIG. 6) of the electrode body 3 forms a positive current collector 3a where the electrode foil of the positive electrode plate 3P is folded into overlapping layers. The lower end portion 6Pa of the positive terminal 6P is joined to the positive current collector 3a. On the other hand, the other end portion (the left end portion in FIG. 6) of the electrode body 3 forms a negative current collector 3b where the electrode foil of the negative electrode plate 3N is folded into overlapping layers. The lower end portion 6Na of the negative terminal 6N is joined to the negative current collector 3b. The electrolyte 4 is contained within the case 2. A portion of the electrolyte 4 is absorbed in the electrode body 3, and the remaining portion of the electrolyte 4 is accumulated at the bottom of the case 2.

In the battery 1, the positive electrode plate 3P is produced by the manufacturing method of the electrode plate described above. Specifically, the above-mentioned active material paste 12P is applied to the surface 11a of the electrode foil 11 in the form of an aluminum foil, and the active material paste 12P is heated and dried. Then, the active material paste 12P is applied to the back surface 11b of the electrode foil 11, and the active material paste 12P is heated and dried. In this manner, the electrode layers 12 are respectively formed on the surface 11a and back surface 11b of the electrode foil 11, so that the positive electrode plate 3P is produced.

Similarly, the negative electrode plate 3N is produced by the manufacturing method of the electrode plate described above. However, in the case of the negative electrode plate 3N, a copper foil, for example, is used as the electrode foil 11, and a mixture of, for example, graphite particles as a negative active material, SBR (styrene-butadiene rubber) as a binder, CMC (carboxymethyl cellulose) as a thickening agent, and ion-exchange water as a solvent is used as the active material paste 12P. The active material paste 12P is applied to the surface 11a of the electrode foil 11 in the form of the copper foil, and the active material paste 12P is heated and dried. Then, the active material paste 12P is applied to the back surface 11b of the electrode foil 11, and the active material paste 12P is heated and dried. In this manner, the electrode layers 12 are respectively formed on the surface 11a and back surface 11b of the electrode foil 11, so that the negative electrode plate 3N is produced.

The manufacturing method of the battery 1 described above includes an electrode body forming step and a housing step. In the electrode body forming step, the electrode body 3 is formed by a known method, using the positive electrode plate 3P produced by the manufacturing method of the electrode plate described above, the negative electrode plate 3N produced by the manufacturing method of the electrode plate described above, and the separators 3S. Then, in the housing step, the electrode body 3 is housed inside the case 2 (the case body 2a) by a known method, and the peripheral edge of the lid 2b is joined to the upper end of the case body 2a. Thus, according to the manufacturing method of the battery 1, the migration phenomenon can be reduced in the positive electrode plate 3P and negative electrode plate 3N in which the migration phenomenon is likely to occur. Accordingly, the battery 1 with high reliability can be manufactured using the positive electrode plate 3P and the negative electrode plate 3N having good bonding strength between the surface 11a of the electrode foil 11 and the electrode layer 12.

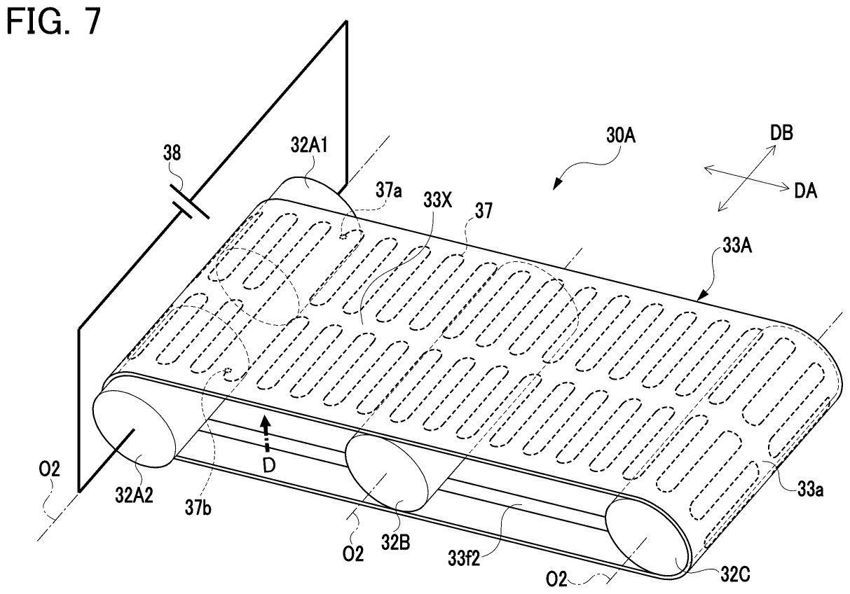

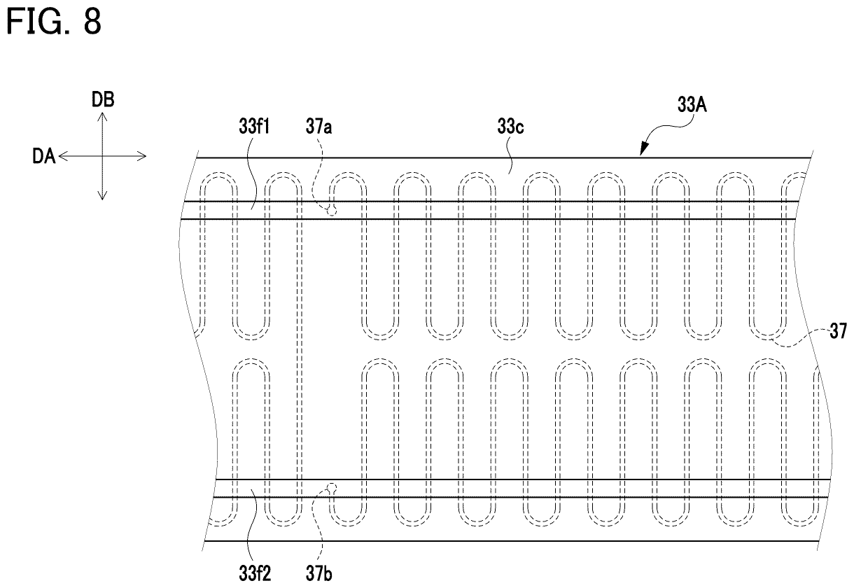

Next, a first modified example will be described with reference to FIG. 7 and FIG. 8. FIG. 7 is a perspective view showing a conveyor belt 33A in the first modified example. In the first modified example, the configuration of the conveyor belt 33A is different from that of the conveyor belt 33 of the above embodiment. As shown in FIG. 7, the conveyor belt 33A of the first modified example incorporates an electric heating wire 37 (heater) extending in a serpentine fashion.

The electric heating wire 37 serves to heat the back surface of the undried electrode plate 10M (the back surface 11b of the electrode foil 11) via the conveyor belt 33A, and is incorporated in a surface-side resin layer 33a of the conveyor belt 33A. As shown in FIG. 7, a drying device 30A of the first modified example is provided with a positive electrode side power supply roller 32A1 and a negative electrode side power supply roller 32A2 in place of the first conveying roll 32A of the above embodiment. The drying device 30A is also provided with a power supply 38. The positive electrode side power supply roller 32A1 and the negative electrode side power supply roller 32A2 are arranged at a distance in the width direction DB. The positive electrode side power supply roller 32A1 is connected to the positive side of the power supply 38, and the negative electrode side power supply roller 32A2 is connected to the negative side of the power supply 38. The positive electrode side power supply roller 32A1 and the negative electrode side power supply roller 32A2 are rotatable about the axis center O2.

FIG. 8 is a rear view of the conveyor belt 33A as seen in the direction of arrow D shown in FIG. 7. As shown in FIG. 8, a positive electrode side terminal plate 33f1 is provided near one end (the upper side in FIG. 8) in the width direction DB of the back surface of the conveyor belt 33A, and a negative electrode side terminal plate 33f2 is provided near the other end (the lower side in FIG. 8) in the width direction DB. The positive electrode side terminal plate 33f1 and the negative electrode side terminal plate 33f2 extend in the longitudinal direction DA and are arranged over the entire circumference on the back surface of the conveyor belt 33A. Therefore, even when the conveyor belt 33A rotates, the positive electrode side terminal plate 33f1 and the negative electrode side terminal plate 33f2 are constantly in contact with the positive electrode side power supply roller 32A1 and the negative electrode side power supply roller 32A2, respectively.

As shown in FIG. 8, one end portion 37a of the electric heating wire 37 is exposed from the conveyor belt 33A (the back-side resin layer 33b) and connected to the positive electrode side terminal plate 33f1. The other end portion 37b of the electric heating wire 37 is exposed from the conveyor belt 33A and connected to the negative electrode side terminal plate 33f2. With this arrangement, current flows from the positive side of the power supply 38 to the negative side of the power supply 38 via the positive electrode side power supply roller 32A1, the positive electrode side terminal plate 33f1, the electric heating wire 37, the negative electrode side terminal plate 33f2, and the negative electrode side power supply roller 32A2, so that the electric heating wire 37 can generate heat.

According to the first modified example, in the surface-side drying step, the belt surface 33X composed of the heat-resistant surface-side resin layer 33a can reduce heat radiation from the back surface of the undried electrode plate 10M (the back surface 11b of the electrode foil 11). Furthermore, since the conveyor belt 33A incorporates the electric heating wire 37, the back surface of the undried electrode plate 10M is heated by the heat generated on the belt surface 33X. As a result, the difference between the temperature of the surface of the active material paste 12P and that of the back surface of the undried electrode plate 10M can be further reduced, and heat radiation from the back surface of the undried electrode plate 10M can be further reduced.

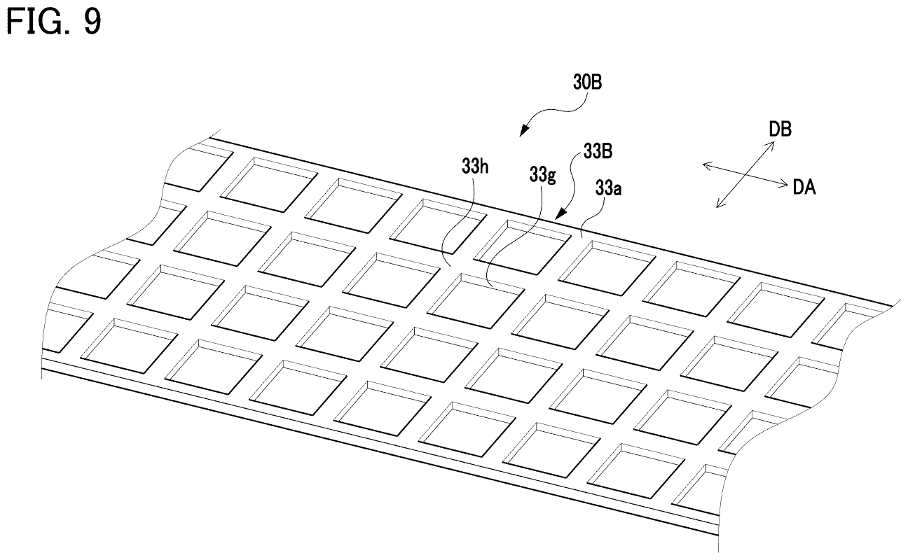

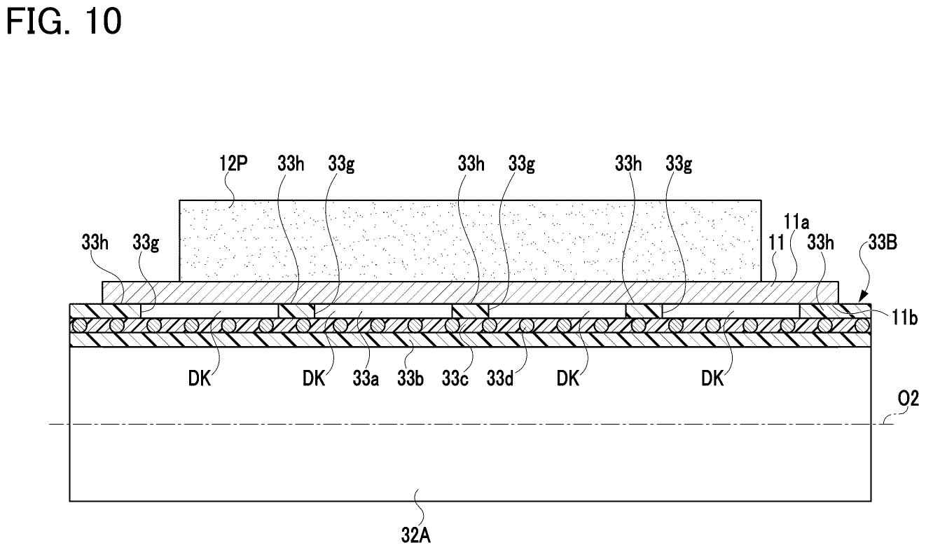

Next, a second modified example will be described with reference to FIG. 9 and FIG. 10. FIG. 9 is a perspective view showing a conveyor belt 33B in the second modified example. In the second modified example, only the configuration of the conveyor belt 33B of a drying device 30B is different from that of the conveyor belt 33 of the drying device 30 in the embodiment described above. As shown in FIG. 9, in the conveyor belt 33B of the second modified example, multiple recesses 33g are provided on the surface side. The recesses 33g are arranged at intervals in the longitudinal direction DA and also arranged at intervals in the width direction DB to thus form a grid pattern. The recesses 33g are formed, for example, by embossing the surface-side resin layer 33a of the conveyor belt 33.

Thus, the surface-side resin layer 33a of the conveyor belt 33B of the second modified example, which has multiple recesses 33g, has multiple protrusions 33h that discretely support the back surface of the undried electrode plate 10M (the back surface 11b of the electrode foil 11), as shown in FIG. 10. In other words, the surface-side resin layer 33a of the conveyor belt 33B provides an uneven resin layer that forms insulating air layers DK between the adhesive rubber layer 33c and the back surface of the undried electrode plate 10M (the back surface 11b of the electrode foil 11).

According to the second modified example, in the surface-side drying step, the area of contact of the surface-side resin layer 33a of the conveyor belt 33B, which is the uneven resin layer, with the back surface of the undried electrode plate 10M (the back surface 11b of the electrode foil 11) is small, and heat is less likely to be transferred from the back surface 11b of the electrode foil 11 to the conveyor belt 33B. Furthermore, since the insulating air layers DK are formed between the back surface of the undried electrode plate 10M and the uneven resin layer, heat radiation from the back surface of the undried electrode plate 10M can be further reduced.

The disclosure has been described in the light of the embodiment and the modified examples. However, the disclosure is not limited to the above-described embodiment and modified examples, but may be applied with changes as needed without departing from the principle thereof.

In the embodiment, the belt surface 33X is configured such that the difference between the temperature of the surface of the active material paste 12P and that of the back surface of the undried electrode plate 10M becomes equal to or less than 15 degrees in the surface-side drying step. However, the difference between the temperature of the surface of the active material paste 12P and that of the back surface of the undried electrode plate 10M is not limited to 15 degrees or less, but the belt surface 33X may be configured such that the temperature difference becomes, for example, 20 degrees or less or 10 degrees or less. However, it is preferable to configure the belt surface 33X such that the difference between the temperature of the surface of the active material paste 12P and that of the back surface of the undried electrode plate 10M becomes as small as possible, in order to reduce heat radiation from the back surface of the undried electrode plate 10M.

While the electric heating wire 37 incorporated in the conveyor belt 33A generates heat in the first modified example, the amount of heat generated by the electric heating wire 37 may be controlled based on the temperature of the back surface of the undried electrode plate 10M or based on the difference between the temperature of the surface of the active material paste 12P and that of the back surface of the undried electrode plate 10M. Specifically, a temperature sensor for detecting the temperature of the back surface of the undried electrode plate 10M and a temperature sensor for detecting the temperature of the surface of the active material paste 12P may be provided, and the amount of heat generated by the electric heating wire 37 may be controlled based on the detection values of the temperature sensors. While the electric heating wire 37 is used as the heater for heating the conveyor belt 33A, a thermoelectric element, for example, may also be used. Thus, the heater may be changed as appropriate.

In the illustrated embodiment, the battery 1 in the form of a lithium-ion secondary battery is manufactured as the power storage device. However, the power storage device may be a sodium-ion secondary battery, a calcium secondary battery, or a capacitor such as a lithium-ion capacitor, and may be changed as appropriate.

Reference Signs List

| | |
|---|---|
| 1 | Battery |
| 2 | Case |
| 3 | Electrode body |
| 10 | Electrode plate |
| 10M | Undried electrode plate |
| 11 | Electrode foil |
| 11a | Surface |
| 11b | Back surface |
| 12 | Electrode layer |
| 12P | Active material paste |
| 20 | Coating device |
| 30, 30A, 30B | Drying device |
| 33X | Belt surface |
| 33A, 33B, 33C | Conveyor belt |
| 33a | Surface-side resin layer |
| 33g | Recess |
| 33h | Protrusion |
| DK | Insulating air layer |

What is claimed is:

1. A method of manufacturing an electrode plate, comprising:
applying an active material paste containing active material particles, a binder, and a solvent to a surface of a strip-shaped electrode foil to form an undried electrode plate; and
drying the active material paste of the undried electrode plate to form an electrode plate that has an electrode layer on the surface of the electrode foil and does not have the electrode layer on a back surface of the electrode foil,
wherein, in drying the active material paste, the undried electrode plate is heated and dried from a surface side while being conveyed in a longitudinal direction with a back surface of the undried electrode plate supported by a conveyor belt, and
wherein the conveyor belt has a belt surface capable of supporting the back surface of the undried electrode plate, and the belt surface comprises a heat-resistant resin layer that reduces heat radiation from the back surface of the undried electrode plate to the outside of the undried electrode plate, over an entire circumference.

2. The method of manufacturing the electrode plate according to claim 1, wherein:
the conveyor belt incorporates a heater that heats the back surface of the undried electrode plate; and
in drying the active material paste, the conveyor belt conveys the undried electrode plate in the longitudinal direction while supporting the back surface of the undried electrode plate, and heats the back surface of the undried electrode plate.

3. The method of manufacturing the electrode plate according to claim 1, wherein the resin layer of the conveyor belt has multiple protrusions that discretely support the back surface of the undried electrode plate, and comprises an uneven resin layer that forms insulating air layers between the conveyor belt and the back surface of the undried electrode plate.

4. The method of manufacturing the electrode plate according to claim 2, wherein the resin layer of the conveyor belt has multiple protrusions that discretely support the back surface of the undried electrode plate, and comprises an uneven resin layer that forms insulating air layers between the conveyor belt and the back surface of the undried electrode plate.

5. A method of manufacturing a power storage device, comprising:
forming an electrode body using the electrode plate manufactured by the method of manufacturing the electrode plate as set forth in claim 1; and
housing the electrode body in a case.

6. A method of manufacturing a power storage device, comprising:
forming an electrode body using the electrode plate manufactured by the method of manufacturing the electrode plate as set forth in claim 2; and
housing the electrode body in a case.

7. A drying device for drying an undried electrode plate in which a surface of a strip-shaped electrode foil is coated with an active material paste containing active material particles, a binder, and a solvent, the drying device comprising:
a heating unit that heats the active material paste of the undried electrode plate from a surface side of the undried electrode plate; and
a conveyor belt that conveys the undried electrode plate in a longitudinal direction while supporting a back surface of the undried electrode plate,
wherein the conveyor belt has a belt surface capable of supporting the back surface of the undried electrode plate, and
wherein the belt surface comprises a heat-resistant resin layer that reduces heat radiation from the back surface of the undried electrode plate to the outside of the undried electrode plate, over an entire circumference.

8. The drying device according to claim 7, wherein the conveyor belt incorporates a heater that heats the back surface of the undried electrode plate.

9. The drying device according to claim 7, wherein the resin layer of the conveyor belt has multiple protrusions that discretely support the back surface of the undried electrode plate, and comprises an uneven resin layer that forms insulating air layers between the conveyor belt and the back surface of the undried electrode plate.

10. The drying device according to claim 8, wherein the resin layer of the conveyor belt has multiple protrusions that discretely support the back surface of the undried electrode plate, and comprises an uneven resin layer that forms insulating air layers between the conveyor belt and the back surface of the undried electrode plate.
